(19) United States
(12) Patent Application Publication
(10) Pub. No.: US 2024/0394508 A1
(43) Pub. Date: Nov. 28, 2024

(54) TRANSFORMER-BASED SURROGATE MODEL MODULE FOR ELECTRIC CIRCUIT PERFORMANCE MODELING

(71) Applicants: INTERNATIONAL BUSINESS MACHINES CORPORATION, ARMONK, NY (US); NEW JERSEY INSTITUTE OF TECHNOLOGY, NEWARK, NJ (US)

(72) Inventors: Shun Zhang, San Mateo, CA (US); Xin Zhang, Chappaqua, NY (US); Shaoze Fan, East Newark, NJ (US); Jing Li, Clifton, NJ (US); Ningyuan Cao, Mishawaka, IN (US); Xiaoxiao Guo, Mountain View, CA (US); Chuang Gan, Cambridge, MA (US)

(21) Appl. No.: 18/323,364

(22) Filed: May 24, 2023

(51) Int. Cl. G06N 3/0442; G06N 3/084

(52) U.S. Cl. CPC G06N 3/0442; G06N 3/084

(57) ABSTRACT

A computing device includes a processor and a storage device coupled to the processor. The storage device stores instructions to cause the processor to perform acts to provide a circuit performance modeling. The acts include identifying and extracting paths of an electric circuit between a plurality of designated components that represent the electric circuit; converting at least one of the extracted paths to a path embedding comprising a vector of a fixed length; and predicting, by a circuit representation-learning model, characteristics of the designated components that represent the electric circuit based on an input of circuit parameters of the electric circuit.

### STATEMENT REGARDING FEDERALLY SPONSORED RESEARCH OR DEVELOPMENT

This application was made with government support under contract number DE-ARO001210 awarded by the U.S. Department of Energy. The government has certain rights to this invention.

### BACKGROUND

### Technical Field

The present disclosure generally relates to electronic design automation (EDA) tools in circuit design, and more particularly to an Artificial Intelligence (AI) assisted EDA tool in analog circuit design.

### Description of the Related Art

Integrated circuit (IC) design is performed with a goal of finding a high-performance circuit in a large space of circuits. Evaluating the performance of ICs in an efficient manner is more important than ever with the increased complexity in designs.

Software simulators are typically used to evaluate the properties of ICs. However, there is an increasing inefficiency when evaluating relatively large numbers of ICs with a simulator. For example, an average software simulation inference time was recently calculated to be about 16.67 seconds averaged over 131 samples. Considering the hundreds of thousands of data points that may be taken into consideration by a software simulator, there is room for improvement in the time spent performing IC evaluations.

### SUMMARY

According to one embodiment, a computing device includes a processor and a storage device coupled to the processor. The storage device stores instructions to cause the processor to perform acts to provide a circuit performance modeling. The acts include identifying and extracting paths of an electric circuit between a plurality of designated components that represent the electric circuit; converting at least one of the extracted paths to a path embedding comprising a vector of a fixed length; and predicting, by a circuit representation-learning model, characteristics of the designated components that represent the electric circuit based on an input of circuit parameters of the electric circuit.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A is an overview of a circuit design evaluation model including a simulator.

FIG. 1B is an overview of a circuit design evaluation model, consistent with an illustrative embodiment.

FIG. 2A shows a surrogate model framework, consistent with an illustrative embodiment.

FIG. 2B illustrates the surrogate model framework of FIG. 2A with an annotation around the path extraction component, consistent with an illustrative embodiment.

FIG. 2C is an enlarged view of the circuit and the path extraction shown in FIG. 2B, consistent with an illustrative embodiment.

FIG. 2D illustrates the surrogate model framework of FIG. 2A with an annotation around the path embedding component, consistent with an illustrative embodiment.

FIG. 2E illustrates is an enlarged view of the path embedding operation for each of the embedded paths mapped to a vector, consistent with an illustrative embodiment.

FIG. 2F illustrates a Bi-Directional Long Short-Term Memory network, consistent with an illustrative embodiment.

FIG. 2G illustrates a surrogate model framework with an annotation of the transformer and MLP, consistent with an illustrative embodiment.

FIG. 3 illustrates the transformer attention mechanism, consistent with an illustrative embodiment.

FIG. 4 illustrates a circuit property prediction using a transformer, consistent with an illustrative embodiment.

FIGS. 5A and 5B illustrate a performance efficiency prediction consistent with an illustrated embodiment.

FIGS. 6A and 6B illustrate a voltage output prediction consistent with an illustrative embodiment.

FIG. 7 is a flowchart illustrating a computer-implemented method of a transformer-based surrogate model module for electric circuit performance modeling, consistent with an illustrative embodiment.

FIG. 8 illustrates a block diagram of a computing environment in accordance with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, the term “transformer” refers to a type of deep learning model. Transformers distinguish from other types of models by performance of self-attention in each part of input, (including a recursive output). A transformer can be used in natural language processing and computer vision.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

### Technical Advantages and Support

It is to be understood that some of the advantages of the present disclosure are provided herein below. However, a person of ordinary skill in the art will appreciate that additional advantages may exist in addition to those described herein.

In an embodiment, a computing device includes a processor and a storage device coupled to the processor. The storage device stores instructions to cause the processor to perform acts to provide a circuit performance modeling. The acts include identifying and extracting paths of an electric circuit between a plurality of designated components that represent the electric circuit; converting at least one of the extracted paths to a path embedding comprising a vector of a fixed length; and predicting, by a circuit representation-learning model, characteristics of the components that represent the electric circuit based on an input of circuit parameters of the electric circuit. Through at least the use of a circuit-representation learning model to predict performance modeling instead of a software simulator, a significantly faster and more efficient circuit performance evaluation is provided.

In an embodiment, which can be combined with the preceding embodiment, the instructions cause the processor to perform an additional act that includes having a multi-layer perceptron network map the represented electric circuit to a scalar value. The mapping of the represented circuit to the scalar value provides for a more efficient performance modeling.

In one or more embodiments, which can be combined with the preceding embodiments, the circuit representation-learning model is a transformer model configured to predict characteristics of the represented electric circuit. The use of the transformer-based surrogate model module achieves a higher accuracy at a faster and more efficient evaluation than a software simulator.

In one or more embodiments, which can be combined with the previous embodiments, the transformer model is a stack of multi-head attention modules. The instructions cause the processor to perform an additional act that includes operating attention mechanism functions in parallel. The multi-head attention modules provide for greater efficiency of operation and increased speed through parallel operation.

In one or more embodiments, which can be combined with the previous embodiments, the instructions cause the processor to perform an additional act that includes embedding the circuit parameters as an input to the transformer model. A faster and increased accuracy of the performance modeling is achieved.

In one or more embodiments, which can be combined with the previous embodiments, the path-embedding model is a bidirectional Long Short-Term Memory (Bi-LSTM) network. The instructions cause the processor to perform an additional act that includes the Bi-LSTM outputs a vector of a fixed length for each path embedding The Bi-LSTM that learns a representation of paths in an electric circuit is more efficient for performance modeling. The fixed vector length enables consideration of different length embedded paths for performance evaluation.

In one or more embodiments, which can be combined with the previous embodiments, the instructions cause the processor to perform an additional act that includes representing the electric circuit as a device embedding input to the Bi-LSTM network. This embedding input to the Bi-LSTM provides for an output path embedding via a pooling operation.

In one or more embodiments, which can be combined with the previous embodiments, the instructions cause the processor to perform an additional act that includes training, by a training model, the circuit representation-learning model from beginning to end. The training module is used to optimize all the parameters from beginning-to-end in the path-embedding, the transformer model, and the multi-layer perceptron network.

In one or more embodiments, which can be combined with the previous embodiments, the training model is a stochastic gradient descent-based model. The stochastic gradient descent-based model has greater efficiency in machine learning to optimize the parameters in the path embedding model.

In one or more embodiments, which can be combined with the previous embodiments, the circuit representation-learning model is a transformer model, and the instructions cause the processor to perform an additional act that includes the stochastic gradient descent-based module processes parameters in the path-embedding, the transformer model, and the multi-layer perceptron network. The stochastic gradient descent-based model in machine learning has more efficiency to optimize path embedding parameters and result in a more accurate circuit representation model.

In one or more embodiments, which can be combined with the previous embodiments, the multi-layer perceptron network has an input size that is the same as an output size of the transformer model. The same size makes for more efficient processing.

In an embodiment, a computer-implemented method of a circuit performance modeling includes identifying and extracting paths between a plurality of designated components that represent an electric circuit. One or more of the extracted paths are converted to respective path embeddings including a vector of a fixed length. Characteristics of the represented electric circuit are predicted based on an input of circuit parameters and the path embeddings of the electric circuit. Through at least the use of a circuit-representation learning model to predict performance modeling instead of a software simulator, a significantly faster and more efficient circuit performance evaluation is provided.

In one or more embodiments, which can be combined with the previous embodiment, the computer-implemented method further includes mapping, by a multi-layer perceptron network, the represented electric circuit to a scalar value.

In one or more embodiments, which can be combined with the previous embodiments, the computer-implemented method further includes predicting the characteristics of the represented electric circuit by a transformer model. The transformer model provides a more efficient machine learning to circuit evaluation using less computational time and computational resources than by using a software simulator.

In one or more embodiments, which can be combined with the previous embodiments, the computer-implemented method further includes embedding the circuit parameters of the electric circuit as an input to the transformer model. The embedding allows mapped to a vector having a fixed length so the network can more accurately present the circuit.

In one or more embodiments, the computer-implemented method further includes training, by a training model, a surrogate model from beginning-to-end. The training model allows for more accurate operations and update of all of the functions being performed in the circuit modeling.

In one or more embodiments, which can be combined with the previous embodiments, the computer-implemented method further includes training the training model to update process parameters for path embeddings, predicting characteristics of the represented circuit and map the electric circuit as a scalar value by the multilayer perceptron network. The training provides for a more efficient and accurate operation.

According to one embodiment, which can be combined with the previous embodiments, a computer program product includes one or more computer-readable storage devices and program instructions stored on at least one of the one or more computer-readable storage devices, the program instructions executable by a processor. The program instructions include program instructions to identify and extract paths between a plurality of designated components that represent an electric circuit; program instructions to convert one or more of the extracted paths to respective path embeddings including a vector of a fixed length; and program instructions to predict, by a transformer model, characteristics of the represented electric circuit based on an input of circuit parameters and the path embeddings of the electric circuit. A much faster and accurate circuit representation is achieved through the use of a transformer model than a circuit simulator.

In one or more embodiments, which can be combined with the previous embodiments, the computer program product includes instructions for mapping, by a multi-layer perceptron network, the represented electric circuit to a scalar value. The mapping to a scalar value makes for a more accurate circuit performance evaluation.

In one or more embodiments, which can be combined with the previous embodiments, the computer program product includes instructions to operate attention mechanism functions in parallel, and to concatenate and transform outputs of the attention mechanism functions for input to the multi-layer perceptron network. A faster and more accurate circuit representing model results through th use of parallel operations.

### Overview

The present disclosure is directed to a machine learning-based framework that provides accurate predictions about circuit performance that is an order-of-magnitude faster than a commonly used software simulator.

In AI-assisted EDA tools in analog circuit design, a typical design procedure includes four sequential phases: a circuit topology design, a physical layout design, a parasitic extraction, and validation. In particular, the circuit topology design remains a challenge in EDA and is performed mainly by human designers based on their knowledge and experience.

There have been attempts to create a circuit design algorithm using AI and reinforcement learning in which a chip architecture corresponds to a maximum Q value. These previous attempts do not involve a model structure, and do not use a transformer learning model to predict the quality of a circuit.

Other attempts to use machine learning for predicting circuit properties have been unsuccessful. For example, a machine learning module includes a netlist analyzer program, a classifier and predictor program and access to a database. Such previous attempts do not disclose a model structure, and do not use a transformer learning model to predict the quality of a circuit. transformer learning models are typically used with Natural Language Processing systems and have yet to be applied to circuit performance evaluation.

A relatively large surrogate model module (which is sometimes referred to as a “surrogate model framework”) makes accurate predictions about the properties of electric circuits. More specifically, the surrogate model module may be a transformer-based deep learning model. A transformer model is typically used for natural language processing. However, in the present disclosure, the transformer is modified for circuit property prediction having higher accuracy and performed in less time than known heretofore.

More particularly, the present disclosure includes designs to assist with encoding a circuit as an input to the transformer (e.g., a deep learning model). The present disclosure includes a path-based representation of electric circuits, a Long-Term Short Term (LSTM)-based model that learns a representation of paths in an electric circuit, and an embedding of the circuit level parameters as an input to a framework.

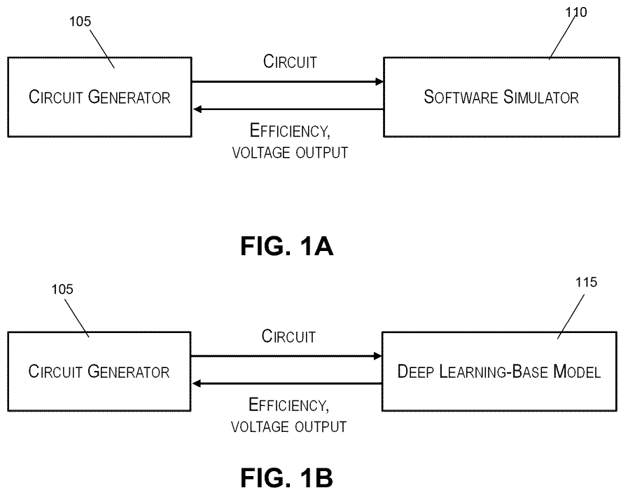

FIG. 1A is an overview of a circuit design evaluation model including a simulator. In a conventional operation, a circuit generator 105 is communicatively linked to a software simulator 110. The software simulator 110 performs circuit evaluation with relatively high accuracy and a computation time of approximately 15-30 seconds per circuit evaluation. Two criterion that are of particular interest are the efficiency and the voltage output of a particular circuit.

FIG. 1B is an overview of a circuit design evaluation model, consistent with an illustrative embodiment. In FIG. 1B, a deep learning-based model 115 is used to perform circuit evaluation. While the deep learning-based model 115 may have comparatively lower accuracy than a conventional software simulator, the computation time is significantly lower than a software simulator. For example, the deep learning-based model takes approximately 11 ms on average of computation time to make a circuit prediction. Through the additional use of a transformer model, the computational accuracy is about as high as the accuracy in conventional methods using a software simulator, however at a fraction of the time. Accordingly, the ability to evaluate complex circuitry is far more efficient than conventional methods, permitting faster evaluations that use fewer computer resources than known heretofore. In addition, as circuit complexity increases, the conventional methods are becoming increasingly impractical for circuit evaluation because of the limitation of approximately 15-30 seconds per circuit. Thus, the transformer based surrogate model module according to the present disclosure provides circuit evaluation of far more complex evaluations more efficiently than known approaches.

### Example Embodiment

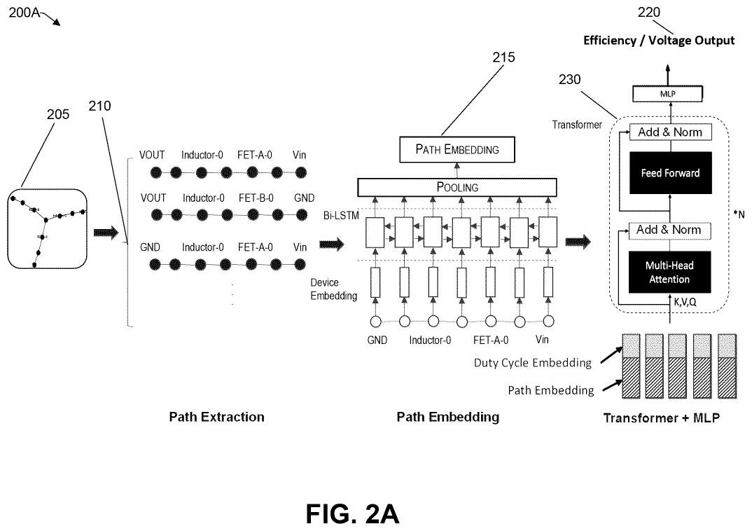

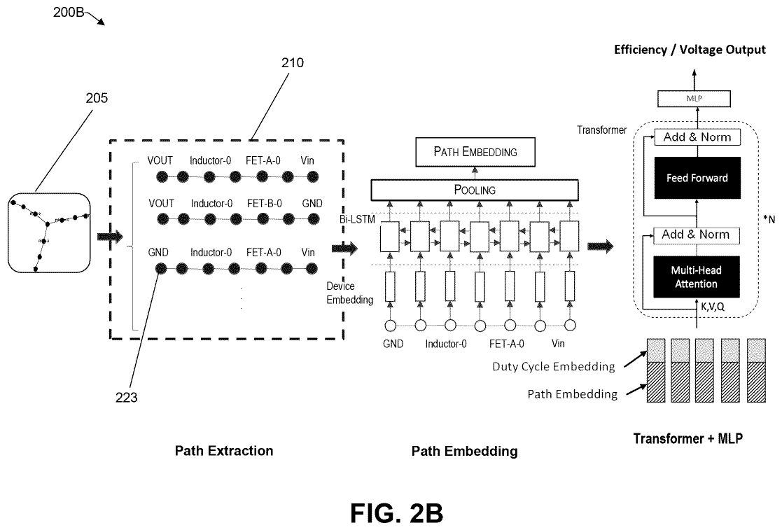

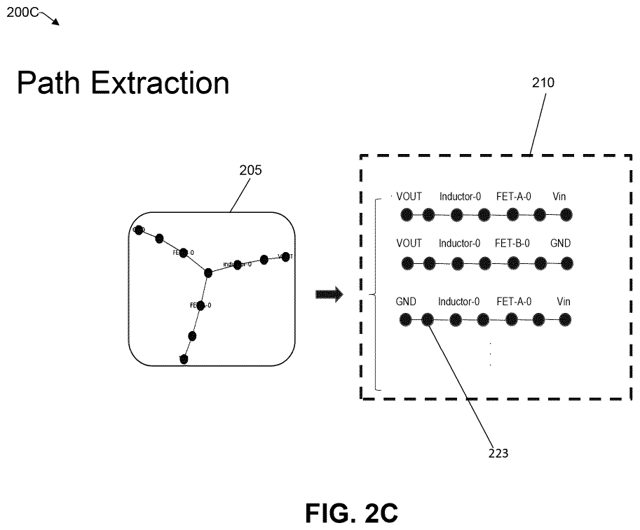

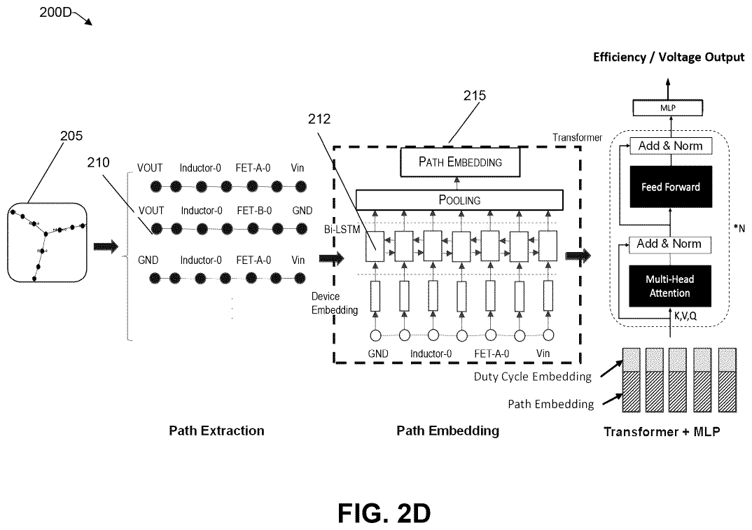

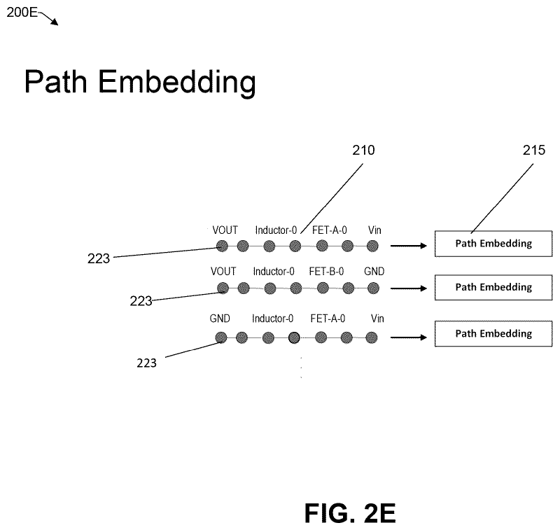

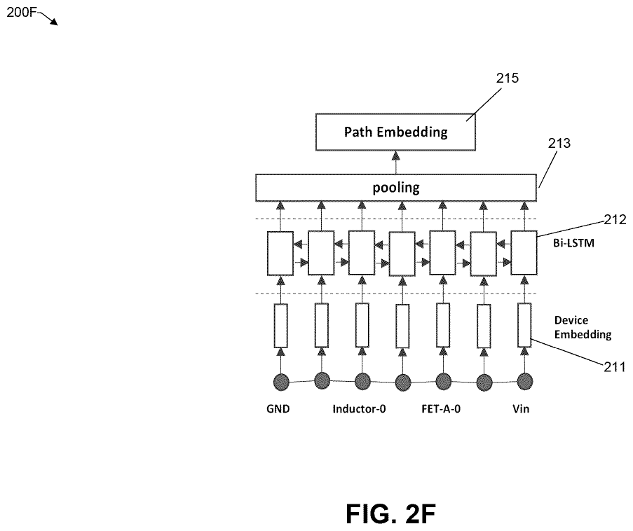

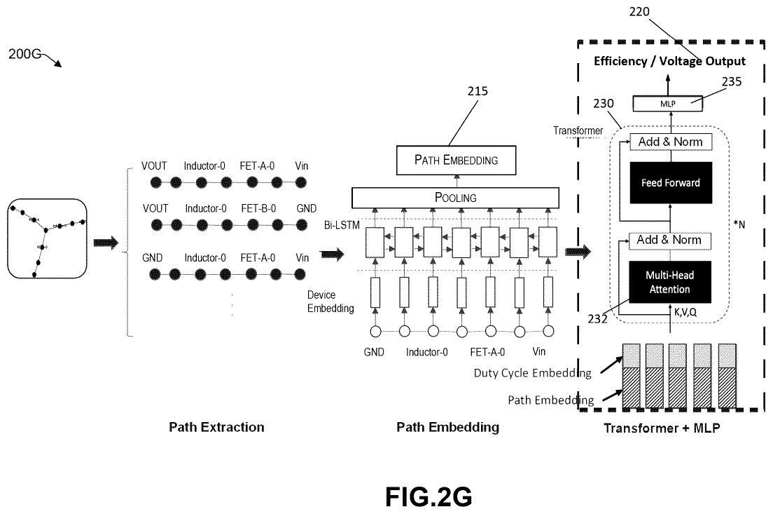

FIG. 2A shows a model framework 200A, consistent with an illustrative embodiment. Shown is a circuit 205 in graphical format, and identified stages of path extraction 210, path embedding 215, and a transformer and multilayer perceptrons (MLP) 230. More particularly, an input of the model framework is the circuit 205 that is defined as a graph with nodes and edges. The output of the framework is and efficiency rating with a computation of a voltage output. The graphical input that represents the circuit 205 is not directly evaluated to provide the efficiency and voltage output information. Accordingly, various components use the graphical input to perform the path extraction, path embedding, and a transformer processing. An efficiency rating and a voltage output of each circuit 205 permits identifying circuit models with the desired performance in far less time than via the use of a software simulator.

FIG. 2B illustrates the model framework 200B of FIG. 2A with an annotation around the path extraction component, consistent with an illustrative embodiment. Moreover, FIG. 2C is an enlarged view 200C of the circuit 205, extracted paths 223 and the path extraction component 210 shown in FIG. 2B. The circuit 205 includes at least three components (VIN, VOUT, GND) that are identified, and the paths between the three components. The circuit 205 is first represented as a graphical input. All of the paths (e.g., Vin-Vout, Vout-Ground, Ground to Vin) extracted between the three components, and the sequence of the extracted paths 223, are used to represent the circuit by the path extraction component 210.

FIG. 2D illustrates the model framework 200D of FIG. 2A with an annotation around the path embedding component, consistent with an illustrative embodiment. Each of the extracted paths from the path extraction 210 may have different lengths. A network may have difficulty in processing paths with different lengths, so in the path embedding 215 each of the extracted paths 223 are mapped to a vector having a fixed length. Mapping the extracted paths 223 to a vector having a fixed length is a unified way of representing the paths. To convert the paths to a vector having a fixed length, a Bidirectional (Bi) Long Term Short Term (LSTM) memory network 212 is used. The Bi-LSTM learns the nodes used in the extracted paths 223 and the relationships of the paths. The Bi-LSTM extracts the nodes and path information and maps the extracted data to a vector having a fixed length.

FIG. 2E is an enlarged view 200E of the path embedding operation for each of the extracted paths 223 mapped to a vector. The model framework first converts an extracted path 223 to a path embedding 215. The path embedding 215 includes a vector of a fixed length. Paths with various lengths have a unique representation.

FIG. 2F illustrates a Bi-Directional Long Short-Term Memory network, consistent with an illustrative embodiment. Each device is first represented by a device embedding 211. The device embeddings 211 are the input of the Bi-LTSM 212, which outputs a path embedding 215 via a pooling 213. The pooling 213 used is average pooling. The disclosure is not limited to average pooling.

FIG. 2G illustrates the transformer attention mechanism, consistent with an illustrative embodiment. The transformer 230 and the MLP model 235 are used to provide an efficiency score and/or a voltage output. The path embeddings 215 are shown as one input parameter. At least one parameter embedding, such as a duty cycle embedding 217, may be another input parameter. These parameters are processed by the transformer 230 to provide the efficiency score and/or a voltage output. The MLP 235 assists in this processing, and provides a mapping of the represented electric circuit 205 to a scalar value.

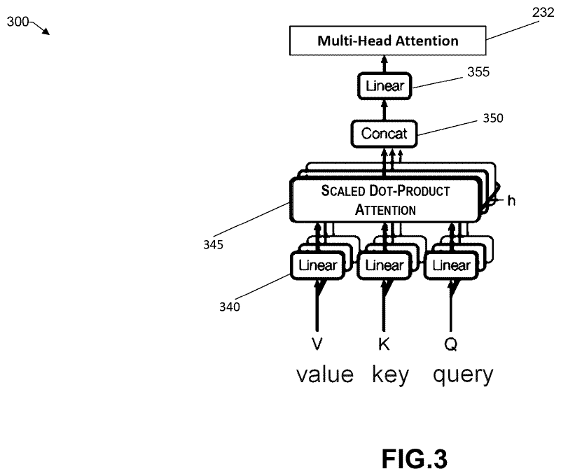

FIG. 3 illustrates a multi-head attention transformer mechanism, consistent with an illustrative embodiment. A multi-head attention mechanism operates attention mechanism functions in parallel. The individual attention outputs are concatenated and linearly transformed. An advantage of using multiple attention heads is to attend to parts of a sequence the sequence differently. The transformer 230 (shown in FIG. 2G) has an attention mechanism 232 that may represent the relevance of two input vectors (e.g., two paths). The transformer attention mechanism learns value, key and query vectors for each input vector. There are linear inputs 340 of value, key, and query (V, K, and Q). A scaled dot-product attention 345 operation, followed by a concatenation 350 and linear processing 355 of the V, K and Q values are performed. The result of the attention mechanism operation results in a multi-head attention. The multi-head attention has four layers when using the same number of spaces.

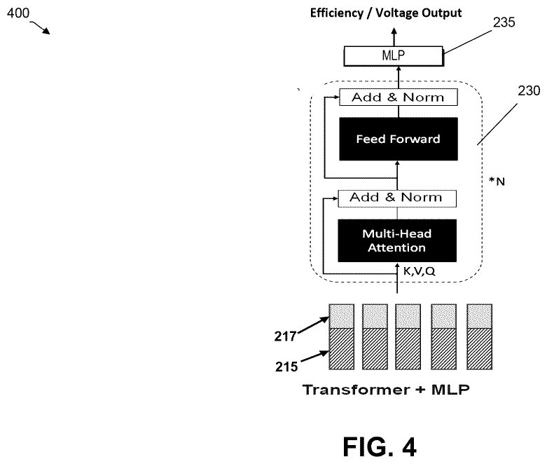

FIG. 4 illustrates a circuit property prediction 400 using a transformer, consistent with an illustrative embodiment. Given the path embeddings of the paths of a circuit, a transformer model 230 takes the path embeddings as an input. The output of the transformer is connected to a multilayer perceptron (MLP), which outputs the predicted property. The parameters of the circuits (e.g., duty cycle) are embedded and concatenated to the input of the transformer.

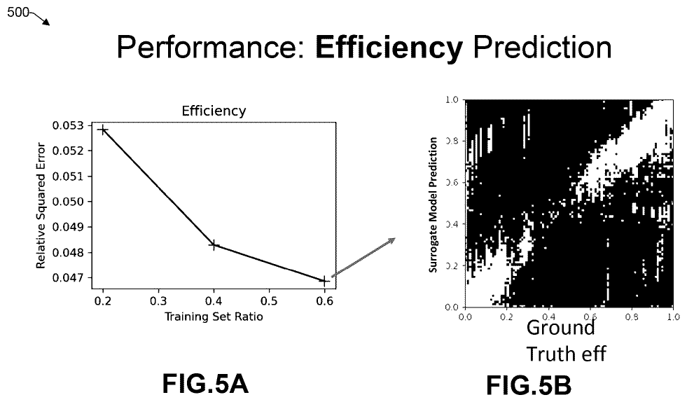

FIGS. 5A and 5B illustrate a performance efficiency prediction 500, consistent with an illustrated embodiment. FIG. 5A shows relative squared errors (RSE) versus a training set ratio. The error decreases as the training set size increases. FIG. 5B shows the ground truth efficiency versus a surrogate model module prediction. The RSE is a model prediction over the sample mean prediction:

$$RSE = \frac{{\sum }_{i = 1}^{n} {( {y}_{i} - {\hat{y}}_{i} )}^{2}}{{\sum }_{i = 1}^{n} {( {y}_{i} - \overline{y} )}^{2}} \begin{matrix}⟵ Model prediction \\ ⟵ Sample mean\end{matrix}$$

where y_i is the ground-truth value, \hat{y}_i is the model's prediction, and Bar{y} is the average ground-truth value. Thus, the numerator of RSE is the error of the model's prediction (how much \hat{y}_i deviates from y_i), and the denominator is the error of simply predicting the mean value.

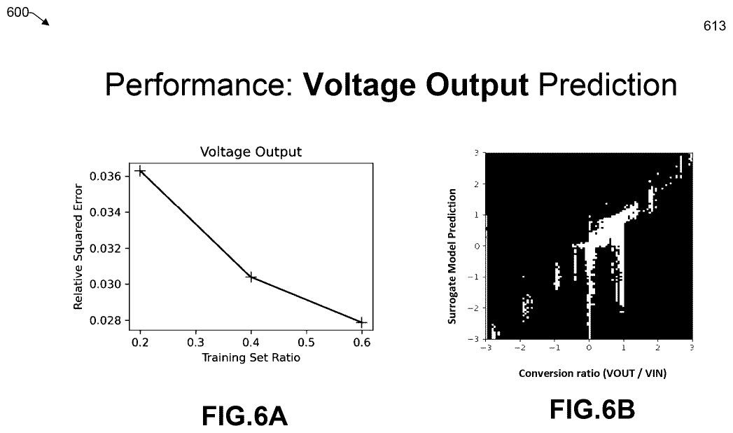

FIGS. 6A and 6B illustrate a voltage output prediction 600, consistent with an illustrative embodiment. FIG. 6A is the training set ratio versus the RSE of a simulator. FIG. 6B shows the conversion ratio (VOUT/VIN) versus the surrogate model module prediction. FIGS. 6A and 6B illustrate that the voltage output prediction is a relatively consistent diagonal line with a few outliers.

### Example Process

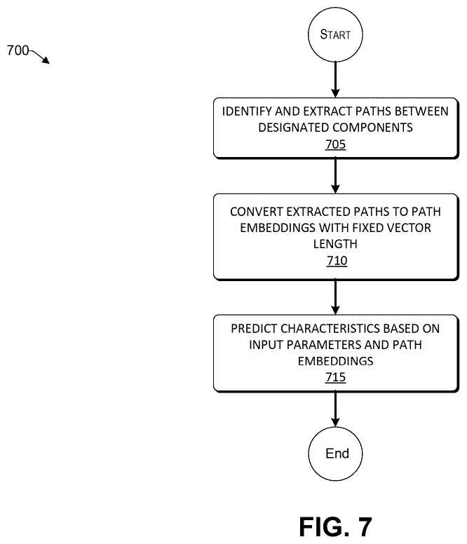

With the foregoing overview of the example architecture, it may be helpful now to consider a high-level discussion of an example process. To that end, FIG. 7 is a flowchart 700 illustrating a computer-implemented method of a transformer-based surrogate model module for electric circuit performance modeling, consistent with an illustrative embodiment. FIG. 7 is shown as a collection of blocks, in a logical order, which represents a sequence of operations that can be implemented in a combination thereof.

Paths are identified and extracted between a plurality of designated components that represent an electric circuit (operation 705). For example, referring to FIG. 2A, there is a graphical representation 205 of a circuit with the nodes and edges. As discussed herein above, the designated nodes (in this example 3) are selected and all of the paths between these nodes are extracted for performance evaluation of the circuit.

Next, the extracted paths are converted to respective path embeddings including a vector of a fixed length (operation 710). FIG. 2E shows paths 210 and path embeddings 215. As shown in FIG. 2F, the conversion may be performed by a Bidirectional (Bi) Long Term Short Term (LSTM) memory 212 network is used. The Bi-LSTM 212 learns the nodes used in the paths and the relationships of the paths. The Bi-LSTM 212 extracts the nodes and path information and maps the extracted data to a vector having a fixed length.

The transformer predicts the characteristics of the represented electric circuit based on an input of circuit parameters and the path embeddings of the electric circuit (operation 715). The parameters of the circuit may include, but are not limited to, duty cycle and path embedding. The parameters are concatenated to the input of the transformer.

Although the basic method ends at operation 715, other operations, such as mapping the represented electric circuit to a scalar value may be performed by a multi-layer perceptron network.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

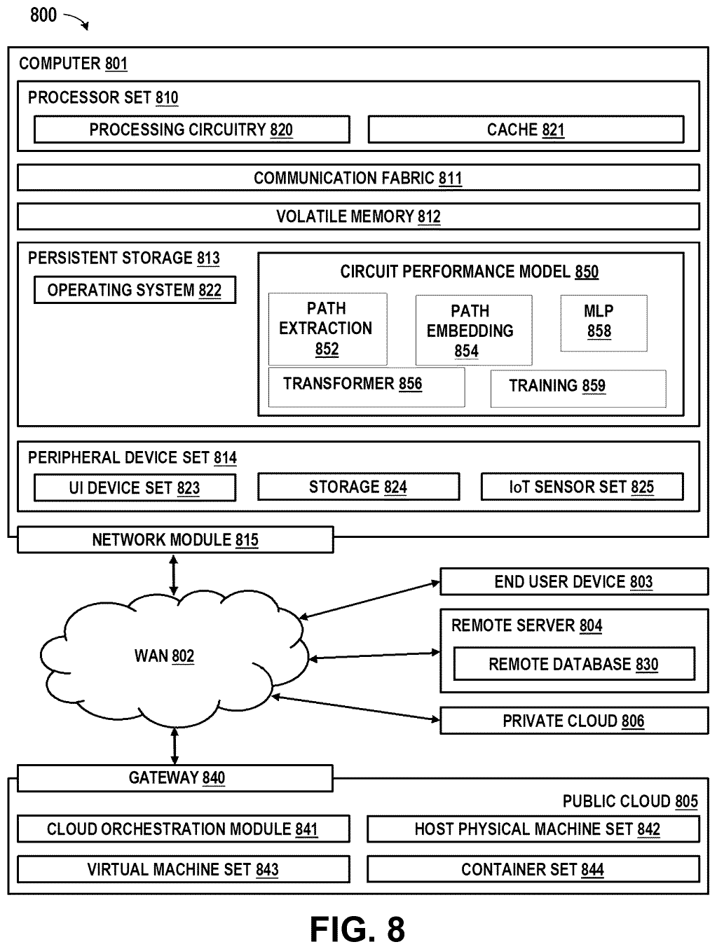

With reference to FIG. 8, the computing environment 800 includes an example of an environment for the execution of at least some of the computer code involved in performing the inventive methods. Computer executable instructions for circuit performance modeling and stored in circuit performance model 850. The path extraction module 852 extracts path information between various components represented graphically such as shown by the circuit 205 (see FIG. 2B). The paths 223 shown in FIG. 2B may then be embedded by path embedding module 854. The path embedding module 854 converts the extracted paths to corresponding vectors having fixed length. The transformer model 856 is a deep learning network that predicts the characteristics of components that represent the circuit 205 based on an input of circuit parameters. The parameters may include duty cycle and path embedding. The MLP model 858 may perform a mapping of the circuit 205 to a scalar value. The training model 859 is used to train and update the transformer model, as well as update the operation of the circuit performance model 850.

In addition, computing environment 800 includes, for example, computer 801, wide area network 802 (WAN), end user device 803 (EUD), remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and Install Advisor Engine 862, as identified above), peripheral device set 814 (including user interface (UI) device set 823, storage 824, and Internet of Things (IoT) sensor set 825), and network module 865. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically Computer 801, to keep the presentation as simple as possible. Computer 801 may be located in a cloud, even though it is not shown in a cloud in FIG. 8. On the other hand, Computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto Computer 801 to cause a series of operational steps to be performed by processor set 810 of Computer 801 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in the install advisor engine 800 in persistent storage 813.

Communication fabric 811 is the signal conduction path that allows the various components of Computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, volatile memory 812 is characterized by random access, but this is not required unless affirmatively indicated. In Computer 801, the volatile memory 812 is located in a single package and is internal to Computer 801, but, alternatively or additionally, the volatile memory may be distributed over multiple packages and/or located externally with respect to Computer 801.

Persistent storage 813 is any form of non-volatile storage for computers that is now known or to be developed in the future. The non-volatility of this storage means that the stored data is maintained regardless of whether power is being supplied to Computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open-source Portable Operating System Interface-type operating systems that employ a kernel. The code included in the Install Advisor Engine 800 typically includes at least some of the computer code involved in performing the inventive methods.

Peripheral device set 814 includes the set of peripheral devices of Computer 801. Data communication connections between the peripheral devices and the other components of Computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where Computer 801 is required to have a large amount of storage (for example, where Computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows Computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to Computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 803 is any computer system that is used and controlled by an end user (for example, a customer of an enterprise that operates Computer 801) and may take any of the forms discussed above in connection with Computer 801. EUD 803 typically receives helpful and useful data from the operations of Computer 801. For example, in a hypothetical case where Computer 801 is designed to provide a recommendation to an end user, this recommendation would typically be communicated from network module 865 of Computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to Computer 801. Remote server 804 may be controlled and used by the same entity that operates Computer 801. Remote server 804 represents the machine(s) that collect and store helpful and useful data for use by other computers, such as Computer 801. For example, in a hypothetical case where Computer 801 is designed and programmed to provide a recommendation based on historical data, then this historical data may be provided to Computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 842 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a storage device coupled to the processor, wherein the storage device stores instructions to cause the processor to perform acts to provide a circuit performance modeling, the acts comprising:
identifying and extracting paths of an electric circuit between a plurality of designated components that represent the electric circuit;
converting at least one of the extracted paths to a path embedding comprising a vector of a fixed length; and
predicting, by a circuit representation-learning model, characteristics of the designated components that represent the electric circuit based on an input of circuit parameters of the electric circuit.

2. The computing device according to claim 1, wherein the instructions cause the processor to perform an additional act comprising mapping, by a multi-layer perceptron network, the represented electric circuit to a scalar value.

3. The computing device according to claim 2, wherein the circuit representation-learning model comprises a transformer model configured to predict the characteristics of the designated components that represent the electric circuit.

4. The computing device according to claim 3, wherein the transformer model includes a stack of multi-head attention modules, and wherein the instructions cause the processor to perform an additional act comprising operating attention mechanism functions in parallel.

5. The computing device according to claim 4, wherein the instructions cause the processor to perform an additional act comprising embedding the circuit parameters of the electric circuit as an input to the transformer model.

6. The computing device according to claim 1, wherein the converting of at least one of the extracted paths to a path embedding is performed by a bidirectional Long Short-Term Memory (Bi-LSTM) network, and wherein the instructions cause the processor to perform an additional act comprising outputting, by the Bi-LSTM network, the vector of a fixed length for each path embedding.

7. The computing device according to claim 6, wherein the instructions cause the processor to perform an additional act comprising representing the electric circuit as a device embedding input to the Bi-LSTM network.

8. The computing device according to claim 2, wherein the instructions cause the processor to perform an additional act comprising training, by a training model, the circuit representation-learning model to perform circuit performance modeling from beginning-to-end.

9. The computing device according to claim 8, wherein the training model comprises a stochastic gradient descent-based model.

10. The computing device according to claim 9, wherein the circuit representation-learning model comprises a transformer model, and wherein the instructions cause the processor to perform an additional act comprising processing, by the stochastic gradient descent-based model, parameters in the path embedding, the transformer model, and the multi-layer perceptron network.

11. The computing device according to claim 10, wherein the multi-layer perceptron network has an input size that is the same as an output size of the transformer model.

12. A computer-implemented method of a circuit performance modeling, the method comprising:
identifying and extracting paths between a plurality of designated components that represent an electric circuit;
converting one or more of the extracted paths to respective path embeddings including a corresponding vector of a fixed length; and
predicting characteristics of the represented electric circuit based on an input of circuit parameters and the path embeddings of the electric circuit.

13. The computer-implemented method according to claim 12, further comprising mapping, by a multi-layer perceptron network, the represented electric circuit to a scalar value.

14. The computer-implemented method according to claim 12, further comprising predicting the characteristics of the represented electric circuit by a transformer model.

15. The computer-implemented method according to claim 14, further comprising embedding the circuit parameters of the electric circuit as an input to the transformer model.

16. The computer-implemented method according to claim 12, further comprising training, by a training model, a circuit performance model from beginning-to-end for circuit performance modeling.

17. The computer-implemented method according to claim 16, further comprising:
training the training model to process parameters for the path embeddings;
predicting the characteristics of the represented electric circuit; and
mapping the represented electric circuit to a scalar value by a multi-layer perceptron network.

18. A computer program product comprising:
one or more computer-readable storage devices and program instructions stored on at least one of the one or more computer-readable storage devices, the program instructions executable by a processor, the program instructions comprising:
program instructions to identify and extract paths between a plurality of designated components that represent an electric circuit;
program instructions to convert one or more of the extracted paths to respective path embeddings including a vector of a fixed length; and
program instructions to predict, by a transformer model, characteristics of the represented electric circuit based on an input of circuit parameters and the path embeddings of the electric circuit.

19. The computing program product according to claim 18, further comprising of program instructions to perform mapping, by a multi-layer perceptron network, of the represented electric circuit to a scalar value.

20. The computing program product according to claim 19, further comprising program instructions to operate attention mechanism functions in parallel, and to concatenate and linearly transform outputs of the attention mechanism functions for input to the multi-layer perceptron network.
